(19) United States
(12) Patent Application Publication
(10) Pub. No.: US 2026/0025010 A1
(43) Pub. Date: Jan. 22, 2026

(54) MODULAR CONVERTER FOR VEHICLE-TO-VEHICLE CHARGING

(71) Applicant: GM GLOBAL TECHNOLOGY OPERATIONS LLC, Detroit, MI (US)

(72) Inventors: Rashmi Prasad, Troy, MI (US); Chandra S. Namuduri, Troy, MI (US)

(73) Assignee: GM GLOBAL TECHNOLOGY OPERATIONS LLC, Detroit, MI (US)

(21) Appl. No.: 18/777,630

(22) Filed: Jul. 19, 2024

(51) Int. Cl. H02J 7/00; B60L 53/20

(52) U.S. Cl. CPC H02J 7/0019; B60L 53/20; B60L 2210/10; H02J 7/007182

(57) ABSTRACT

A converter system, e.g., for vehicle-to-vehicle charging, includes galvanically-isolated modular first and second converters having the same maximum voltage rating, a direct current (DC) voltage bus interconnecting the converters, and an electronic controller. An input voltage to the DC bus is converted into an output voltage via switching control signals to the modular converters. The system's voltage rating may equal the maximum of the input and/or output voltage, or it may equal the maximum input voltage and be about 50-percent of the maximum output voltage. The maximum input and output voltages may be equal. When the voltage rating is about 50-percent of the maximum input voltage, capacitors may be connected in parallel with the modular converters on an input side thereof. Switching circuits may be connected to the bus to control the conversion of the input voltage via switching control signals.

### INTRODUCTION

Battery electric vehicles as well as plug-in hybrid electric vehicles and extended-range electric vehicles, collectively referred to herein as EVs for simplicity, are equipped with an electrified powertrain system. An electrified powertrain system includes one or more electric motors connected to a load. In an EV, a battery management system controls discharge of a high-voltage rechargeable energy storage system (RESS) during propulsion modes to energize the electric motor(s) and produce motor output torque. The EV is thereby propelled along a road surface via electrically-driven rotation of one or more road wheels acting as the above-noted load, with engine-driven rotation also being possible in hybrid electric and extended-range electric vehicle configurations.

The RESS when embodied as an EV traction battery pack includes a plurality of electrochemical battery cells, for instance lithium-ion, lithium-metal, or another application-suitable battery chemistry. The constituent battery cells of a depleted traction battery pack are selectively rechargeable using an offboard plug-in charging process. Other RESS constructions such as fuel cells, ultracapacitors, or hybrid-type alternative electrical storage systems may be similarly recharged. As appreciated in the art, offboard charging of an EV or other battery electric system requires the exemplary traction battery pack to be electrically connected to Electric Vehicle Supply Equipment (EVSE), i.e., an offboard charging station, via a suitably configured charging cable. Communication and control circuitry and respective controllers of the charging station and the EV establish two-way communications in accordance with a suitable charging protocol. The charging station thereafter offloads a charging current to the depleted traction battery pack to charge the individual battery cells.

### SUMMARY

Disclosed herein is a modular direct current-to-direct current (DC-DC) converter architecture for use in a portable charging unit, as well as systems and methods for performing mobile charging operations between a charge-providing electrical system (“donor”) and a charge-receiving electrical system (“recipient”) using the modular DC-DC converter. The disclosed architecture and charging strategy enables a high-voltage energy transfer to occur between the donor and recipient.

In a representative and non-limiting construction as set forth herein, the donor and recipient are battery electric systems in the form of electric vehicles (EVs) having a traction battery pack as part of a rechargeable energy storage system (RESS). The EVs may be variously embodied as battery electric vehicles, plug-in hybrid electric vehicles, extended range electric vehicles, or another electrified mobile system having a high-voltage traction battery pack. However, the present teachings may be extended to charging events performed using stationary or non-vehicular electrical systems within the scope of the present disclosure, with the RESS possibly including the above-noted fuel cells, ultracapacitors, or hybrid-type alternative electrical storage systems. Therefore, EV/battery electric systems described herein are merely representative of the present teachings and not limiting thereof.

In a particular embodiment, a DC-DC converter system includes a galvanically-isolated and modular first DC-DC converter having a predetermined voltage rating, a galvanically-isolated and modular second DC-DC converter having the predetermined voltage rating, a DC voltage bus interconnecting the first and second converter, and an electronic controller. The controller is configured to convert an input voltage of the DC voltage bus into an output voltage via switching control signals to the first DC-DC converter and the second DC-DC converter.

The predetermined voltage rating in one or more embodiments is equal to at least one of a maximum of the input voltage (i.e., a rated voltage) or a maximum of the output voltage. The predetermined voltage rating may be equal to the maximum of the input voltage, which in turn is optionally about 50-percent of the maximum of the output voltage. Alternatively, the maximums of the input voltage and output voltage are equal.

A first capacitor in some implementations is connected in parallel with the first DC-DC converter on an input side thereof. A second capacitor is similarly connected in parallel with the second DC-DC converter on an input side thereof.

Embodiments of the DC-DC converter system include a first switch circuit connected to the DC voltage bus and having a first plurality of switches, along with a second switch circuit connected to the DC voltage bus and having a second plurality of switches. The electronic controller, in response to input signals indicative of the input voltage and the output voltage, may be configured to control an ON/OFF switching state of the first and second pluralities of switches. This action converts the input voltage into the output voltage via the switching control signals.

The first plurality of switches may include a first switch, a second switch, and a third switch. The second plurality of switches may include a fourth switch, a fifth switch, and a sixth switch. In such an embodiment, the electronic controller may command the first switch, the second switch, the fifth switch, and the sixth switch to close and the third switch and the fourth switch to open. Such actions may occur in response to the input voltage and the output voltage being equal to the predetermined voltage rating. The electronic controller may also command the first switch, the second switch, the fourth switch to close and the third switch, fifth switch, and the sixth switch to open, which occurs in response to the input voltage being equal to the predetermined voltage rating and the output voltage being twice the input voltage.

The electronic controller may also be configured to command the third switch and the fourth switch to close and the first switch, the second switch, the fifth switch, and the sixth switch to open, this time in response to the input voltage and the output voltage being equal to twice the predetermined voltage rating.

Alternatively, the electronic controller may command the third switch, the fifth switch, and the sixth switch to close and the first switch, the second switch, and the fourth switch to open. These actions may be commanded in response to the input voltage being equal to twice the predetermined voltage rating and the output voltage being equal to the predetermined voltage rating.

The DC-DC converter system in one or more embodiments may be connected to and/or within a housing of a vehicle-to-vehicle charging unit, the input voltage is a battery voltage level of a traction battery pack of a donor EV, and the output voltage is a battery voltage level of a traction battery pack of a recipient EV.

Also disclosed herein is a vehicle system having a charge-providing donor EV, a charge-receiving recipient EV, and a portable V2V charging unit. The V2V charging unit for its part includes an electronic controller and a DC-DC converter system for use in performing a V2V charging process between the donor EV and the recipient EV. The DC-DC converter system may include galvanically-isolated and modular first and second DC-DC converters having a predetermined voltage rating, along with a DC voltage bus having input terminals, output terminals, and interconnecting the first DC-DC converter and the second converter. The electronic controller may be used to convert an input voltage of the DC voltage bus into an output voltage via switching control signals to the first and second DC-DC converters.

Aspects of the disclosure pertain to a DC-DC charging process, and embodiment of which includes detecting, via an electronic controller of a portable charging unit when the charging unit is connected to a charge-providing electrical system (“donor”) and a charge-receiving electrical system (“recipient”), respective voltage capabilities of a donor-side battery and a recipient-side RESS of the respective donor and recipient. In response to the respective voltage capabilities, the process includes converting an input voltage of a DC voltage bus within the charging unit into an output voltage. This occurs via transmission or provision of switching control signals to a galvanically-isolated, modular first DC-DC converter and a galvanically-isolated, modular second DC-DC converter of the charging unit. A predetermined voltage rating of the first DC-DC converter in this particular embodiment is equal to a predetermined voltage rating of the second DC-DC converter.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is an illustration of a representative vehicle-to-vehicle (V2V) charging session performed between a charge-providing electric vehicle (“donor EV”) and a charge-receiving electric vehicle (“recipient EV”) using a portable V2V charging unit and a resident modular direct current-to-direct current (DC-DC) converter system as disclosed herein.

FIG. 2 illustrates a representative embodiment of the portable V2V charging unit of FIG. 1.

FIG. 3 depicts a DC-DC converter system having a matched pair of isolated DC-DC converters and a switching circuit constructed in accordance with an aspect of the disclosure.

FIG. 4 is a table describing possible voltage levels and ON/OFF switch states for the representative DC-DC converter system of FIG. 3.

FIGS. 5A, 5B, 5C, and 5D illustrate representative configurations of the DC-DC converter system for possible donor and recipient voltage capabilities.

FIG. 6 is a flow chart illustrating a method for performing a V2V charging session using the representative DC-DC converter system of FIG. 3.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

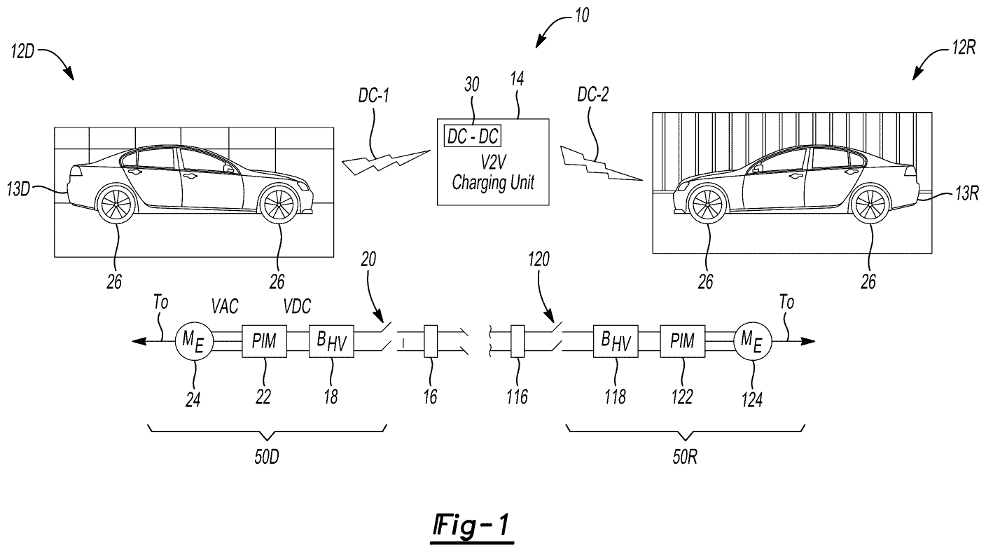

Referring to the drawings, wherein like reference numbers refer to like features throughout the several views, FIG. 1 depicts a representative vehicle-to-vehicle (V2V) charging process 10. During the V2V charging process 10, a charge-providing electrical system in the non-limiting form of an electric vehicle (EV), hereinafter referred to as a donor EV 12D for simplicity, offloads a high-voltage direct current (DC) charging current (DC-1) to a portable V2V charging unit 14. The V2V charging unit 14 in turn delivers a DC charging current (DC-2) to a charge-receiving EV, i.e., a recipient EV 12R using, in part, a modular isolated DC-DC converter system 30.

As appreciated in the art, DC-DC converter strategies for use in V2V charging are often required to accommodate a wide voltage range. For example, nominal EV voltage ranges of about 400V to about 800V may be encountered. Within this exemplary voltage range, 400V and 800V serve as respective lower and upper range limits. To accommodate charging of vehicles or other electrical systems having such widely disparate voltage capabilities, DC-DC converter topologies are typically configured to handle input and output voltages falling anywhere within an expected range. However, accommodation of charging at the upper limit, i.e., 800V in this non-limiting example, requires the hardware components of the DC-DC converter to be more robust in order to handle, e.g., increased voltage and thermal stress. As a result, wide-range DC-DC converter topologies tend to be much larger, heavier, and less efficient to implement. In lieu of a wide-range converter, therefore, the present teachings rely on the use of modular “building blocks” of multiple lower-voltage converters, for example nominal 400V converters in keeping with the non-limiting 400V-800V example voltage range, that may be either preconfigured or configured in real-time as set forth below.

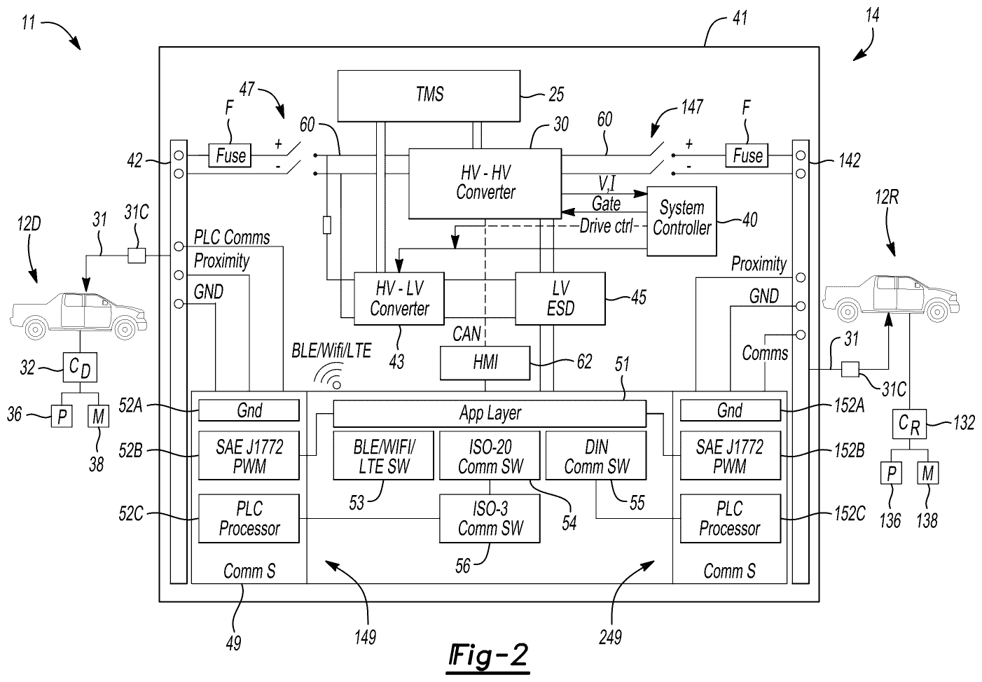

As described below with reference to FIGS. 2-6, the DC-DC converter system 30 is constructed with lower voltage devices, e.g., 400V class switches and other hardware, and provides the ability to connect such building block/modular converters in series or parallel arrangements to better match a voltage level of the donor EV 12D with that of the recipient EV 12R. Thus, as used herein the term “modular” entails the use of standardized converters (“building blocks”) for easy construction or flexible arrangement of the DC-DC converter system 30. The DC-DC converter system 30 is characterized by an absence of a wide input range converter and thus operates with improved efficiency. Embodiments of the DC-DC converter system 30 may be adjustable in real-time in preparation for the V2V charging process 10 or factory preconfigured, with both construction options described in detail hereinbelow.

The donor EV 12D and the V2V charging unit 14 of FIG. 1 together appear, from the perspective of the recipient EV 12R, as an offboard electric vehicle supply equipment (EVSE) charging station of type noted above. However, in contrast to offboard EVSE charging stations capable of providing DC fast charging functionality, the portability and configured functionality of the V2V charging unit 14 described below offers owners/operators of EVs and other electrified systems the benefit of enhanced charging mobility and reduced range anxiety, among other attendant benefits. While the donor EV 12D and recipient EV 12R are representative of a possible vehicular implementation of the present teachings, those skilled in the art will appreciate that the other battery electric systems, stationary or mobile, may benefit from the present teachings. For example, the V2V charging unit 14 may be used to offload the DC charging current (DC-2) to a rail vehicle/train, boat, aircraft, robot, service vehicle, transportation vehicle, or another suitably equipped mobile platform having an onboard rechargeable energy storage system (RESS). Vehicular embodiments described herein are therefore illustrative and non-limiting.

The donor EV 12D and the recipient EV 12R as contemplated herein respectively include a body 13D, 13R and a corresponding electric powertrain system 50D, 50R. In a typical configuration, the donor EV 12D includes a charging port 16 that is connected to a high-voltage (HV) rechargeable energy storage system (RESS) 18. For illustrative consistency, the RESS 18 is described hereinafter as being an electrochemical traction battery pack (BHV) 18 without limiting its construction. As noted above, the battery pack 18 may be alternatively configured as a fuel cell system, ultracapacitor, or hybrid energy storage system in different constructions. Connection of the traction battery pack 18 occurs via operation of a set of electrical contactors 20 or other actuatable HV disconnect devices. The traction battery pack 18 in turn is connected to a power inverter module (PIM) 22, i.e., an inverter circuit. In a discharging mode, the traction battery pack 18 delivers a DC voltage (VDC) to a DC-side of the PIM 22. The PIM 22, using ON/OFF conductive state control of multiple solid-state semiconductor switches (not shown) such as insulated gate bipolar transistors (IGBTs), metal-oxide-semiconductor field-effect transistors (MOSFETs), thyristors, or the like, is driven by pulse-width modulation (PWM) signals or another suitable switching control technique.

Switching control of the PIM 22 ultimately converts the DC input voltage from the traction battery pack 18 into an alternating current voltage (VAC) suitable for energizing phase windings of an electric traction motor (M_{E}) 24, thus causing machine rotation. Output torque (arrow T_{O}) from the electric traction motor 24 is then delivered to one or more road wheels 26 of the donor EV 12D. The recipient EV 12R shown in FIG. 1 may be similarly or identically configured to include a corresponding charge port 116, traction battery pack 118, contactors 120, PIM 122, and electric traction motor 124. Thus, in addition to being equipped to perform the V2V charging process 10 of FIG. 1, the respective electric powertrain systems 50D and 50R are also configured, during separately conducted discharging modes of the battery packs 18 and 118, to electrically propel the corresponding donor EV 12D and recipient EV 12R.

Referring to FIG. 2, a situation could arise during operation of the recipient EV 12R in which the traction battery pack 118 becomes charge-depleted to the extent that the owner/operator of the recipient EV 12R requires charging. When this occurs, the recipient EV 12R might not be in sufficiently close proximity to an available EVSE charging station, or to a home or office charging station. In such a scenario, the owner/operator may request performance of the V2V charging process 10 of FIG. 1 as a mobile charging session. During this event, the portable V2V charging unit 14 could be transported to the site of the recipient EV 12R, e.g., via the donor EV 12D or another vehicle/third party provider or roadside assistance vehicle and thereafter connected, via charging cables 31 and the charging ports 16, 116, to the donor EV 12D and the recipient EV 12R. The charging ports 16 and 116 may be variously configured to receive SAE J1772, national charging standard (NACS), combined charging system (CCS), CHAdeMO, or other suitable charge connectors depending on the embodiment.

The donor EV 12D includes an onboard vehicle controller (C_{D}) 32 having one or more processors (P) 36 and a non-transitory computer-readable storage medium/memory (M) 38. The recipient EV 12R is similarly equipped with a vehicle controller 132 (C_{R}), processor(s) (P) 136, and memory (M) 138. Thus, the donor EV 12D and the recipient EV 12R are equipped to communicate via the exchange of data during the V2V charging process 10, manage and coordinate powerflow, monitor for proper connection of the charging cables 31 and other conditions/error states, regulate temperature of the V2V charging unit 14, and perform other relevant functions during the V2V charging process 10.

To perform the V2V charging process 10 using the DC-DC converter system 30 described herein, the vehicle controllers 32 and 132 work in concert with the V2V charging unit 14 to perform the process steps as set forth below. Such functions are embodied computer-readable instructions and executed from the memory 38 and 138, for instance magnetic or optical media, CD-ROM, and/or solid-state/semiconductor memory (e.g., various types of RAM or ROM). The term “vehicle controller” and related terms such as control module, control unit, processor, and similar terms may refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). Non-transitory components of the memory 38 and 138 used herein are capable of storing machine-readable instructions in the form of one or more software or firmware programs or routines, combinational logic circuit(s), input/output circuit(s) and devices, signal conditioning and buffer circuitry and other components that can be accessed by one or more processors 36 and 136 to provide a described functionality.

In the representative configuration of FIG. 2, the V2V charging unit 14 is configured to output a rated charging power of at least about 50-100 kilowatts (kW) of continuous power, and about 150-300 amps (A) of continuous output current. In a possible construction, the V2V charging unit 14 may receive about 300V-1000V or more from the donor EV 12D, and in response, may output about 150V-500V or more to the recipient EV 12R, with other voltage ranges being possible depending on the embodiment. For instance, the maximum of the input voltage to the recipient EV 12R in one or more embodiments may be about 50-percent of a maximum of the output voltage from the donor EV 12D. A maximum of the input voltage may be equal to a maximum of the output voltage in other constructions. The V2V charging unit 14 is also configured with buck/boost capabilities to enable the V2V charging unit 14 to decrease (buck) or increase (boost) the DC voltage (DC-1 of FIG. 1) provided from the donor EV 12D, with the V2V charging unit 14 doing so based on state of charge (SOC) or voltage capability of the traction battery pack 118 of the recipient EV 12R, an amount of requested power, power capability/SOC/voltage capability of the donor EV 12D, and other factors.

Mobile plug-in functions as contemplated herein involve the coordinated two-way communication of data between the donor EV 12D and the recipient EV 12R. Data exchange takes the form of a low-voltage control pilot or communications (Comms) signal, typically in the range of 0-12V, and a proximity voltage signal of 0-5V. An electrical ground (GND) is also provided. An established J1772 connection, for instance, allows respective processors of the donor EV 12D and the recipient EV 12R to communicate with each other using Power Line Communication (PLC) for the comms signal, which in turn progresses in accordance with an established communications protocol via a coordinated exchange of data messages. The comms signal is ordinarily used to verify a connection between an offboard EVSE charging station and a charging EV, whose respective places are taken herein by the donor EV 12D and the V2V charging unit 14 (together acting as such an EVSE charging station) and the recipient EV 12R, to communicate charging states. This may occur, e.g., using a fixed PWM duty cycle during the contemplated DC charging. The same signal may be used to adjust the charging rate as needed. Other standards such as the above-noted NACS, CCS, CHAdeMO, etc., may be used in a similar vein, and therefore the particular charging standard may vary with the desired end use.

Multi-pin charging plugs 30C disposed the charging cables 31 are connected to a corresponding one of the charging ports 16, 116 located on the donor EV 12D and recipient EV 12R, respectively (see FIG. 1). In accordance with the relevant charging protocol, DC charging power is fed through conductive pins of the charging port 16 of the donor EV 12D, across the V2V charging unit 14, and into the traction battery pack 118 of the recipient EV 12R. The charging process is coordinated via an exchange of data/messages between the processor 36 of the donor EV 12D of FIG. 2, an electronic system controller 40 of the V2V charging unit 14, and the corresponding processor 136 the recipient EV 12R, e.g., a Battery Management System or another battery controller. The above-noted comms and proximity signals are exchanged between the processors 36 and 136 the system controller 40, with the general process of DC charging under DIN 70121 or other relevant protocols being well understood in the art. Also as understood in the art, such protocols proceed in accordance with a defined multi-step electronic “handshaking” process before permitting transfer of energy.

V2V CHARGING UNIT (14): the V2V charging unit 14 illustrated in FIG. 2, which is configured to function as a mobile charging accessory for performing a V2V charging event/session, may include a portable housing 41, for instance a weatherproof, rugged, and sufficiently lightweight enclosure constructed of molded plastic, aluminum, steel, etc. Portability of the housing 41 may be facilitated by connecting or affixing wheels and/or handles (not shown) to the housing 41. The housing 41 is also connected to respective inlet and outlet charging ports 42 and 142, which in turn are respectively connectable to the donor EV 12D and the recipient EV 12R during the V2V charging process 10 of FIG. 1.

The above-noted DC-DC converter system 30 is arranged within a cavity or volume defined by the housing 41 and securely connected to the housing 41 for secure transport and operation. In the illustrated embodiment of FIG. 2, the DC-DC converter system 30 may be configured as an HV boost-buck converter or a buck-boost converter. As appreciated in the art, “buck” and “boost” respectively refer to DC voltage-reducing and voltage-increasing stages. A high-voltage-to-low-voltage (HV-LV) converter 43 is also included in the circuitry of the V2V charging unit 14. Unlike DC-DC converters adapted for a wide operating range, e.g., the exemplary 400V to 800V range described above, which require switches and other components to be rated for the highest anticipated voltage levels, the present DC-DC converter system 30 is modular and scalable to the actual voltage levels of the donor EV 12D and recipient EV 12R. Modular/scalable options are described below with reference to FIGS. 3-5D and controlled in accordance with the method 100 of FIG. 6.

An optional LV energy storage device 45, e.g., an electrochemical battery pack, an ultracapacitor, or a supercapacitor in different implementations, may be connected to a low-voltage side of the HV-LV converter 43 as shown, or LV power could be provided separately, e.g., via a plug-in connection to onboard/on-vehicle 12-15V power. The optional LV energy storage device 45 when used is also electrically connected to the DC-DC converter system 30 to provide low-voltage (e.g., nominal 12-15V) power suitable for opening/closing HV disconnect devices 47 and 147, and for powering voltage or current sensors and associated circuit and diagnostic components. The connection of the LV energy storage device 45 and the HV-LV converter 43 also enables the HV-LV converter 43 to selectively charge the LV energy storage device 45 during the V2V charging process 10. The optional LV energy storage device 45 may also be recharged via AC grid power in some configurations, e.g., by plugging the housing 41 into an available wall socket via a corresponding charging outlet (not shown) arranged thereon.

The V2V charging unit 14 illustrated in FIG. 2 also includes a communication processing unit 49 operable for establishing and maintaining two-way communication between the donor EV 12D and the recipient EV 12R during the V2V charging process 10 of FIG. 1. Separate communication circuits/stacks or “comm stacks” 149 and 249 (Comm S) may be included in the communication processing unit 49, with an application layer 51 arranged therebetween to coordinate wired/wireless data exchange. Comm stacks 149 and 249 in the non-limiting embodiment of FIG. 2 may include different connections and components, e.g., a ground (GND) connection 52A, an SAE J1772 PWM block 52B, and a PLC processor 52C for the comms stack 149, or equivalent structure in other embodiments, and corresponding ground connection 152A, PWM block 152B, and process 152C for the comms stack 249.

To that end, the CPU 49 may be equipped, during the V2V charging process 10, to coordinate with the above-noted processors 36 and 136 of the respective donor EV 12D and recipient EV 12R. Communication is facilitated via one or more communication modules connected to/usable with the application layer 51, e.g., a BLE/WiFi/LTE software module 53, ISO-20 communications software module 54, DIN communications software module 55, and ISO-3 communications software module 56 as shown in the non-limiting example construction of FIG. 2. Such software is typically used during EV charging to facilitate the wireless exchange of data, and thus is well understood in the art.

Still referring to FIG. 2, by using the comms stacks 149 and 249, the application layer 51, and the associated software modules 53, 54, and 55, the CPU 49 is able to command the HV-LV converter 43 to pre-charge a high-voltage DC voltage bus, i.e., HV bus 60, of the V2V charging unit 14 to a level equal to that of an HV bus located on the donor EV 12D, and in selectively recharging the LV energy storage device 45 via the HV-LV converter 43 as needed. Additionally, the CPU 49 (in close coordination with the processors 36 and 136 of FIG. 2) selectively commands offloading of a DC charge from the traction battery pack 18 of the donor EV 12D of FIGS. 1 and 2 to the traction battery pack 118 of the recipient EV 12R through operation of the DC-DC converter system 30.

The DC-DC converter system 30 described below is connectable on positive and negative HV rails (+, −) between the inlet charging port 42 and the outlet charging port 142 via the first and second sets of HV disconnect devices 47 and 147, respectively. Fault isolation devices (F) such as fuses, pyrotechnic switches, or e-fuses may be arranged as shown to provide additional high-voltage protection.

Other components of the V2V charging unit 14 of FIG. 2 may include a human-machine interface (HMI) 62 connected to the housing 41 and configured to facilitate interaction-machine interactions during the course of the V2V charging process 10 described herein. The HMI 62 may receive user inputs to the system controller 40 during the V2V charging process 10, and may also display information pertaining to the V2V charging process 10 for viewing by users of the V2V charging unit 14. For example, the HMI 62 could include one or more display screens, alphanumeric touchscreens, push button keyboards, and/or other peripheral devices that present prompts and sequential instructions for the owner/operator to follow. The HMI 62 could likewise present information to the user(s), such as the current communication and charge offloading statuses of the V2V charging process 10, SOC, voltage, or other status of the traction battery packs 18 and 118 of the respective donor EV 12D and recipient EV 12R, charging time and offloaded power total, etc. A controller area network (CAN) bus may be included in the architecture of the V2V charging unit 14 to communicate between the various modules or devices using low-voltage differential signals.

Additionally, a thermal management system (TMS) 25 may be incorporated into the V2V charging unit 14 or connected thereto to regulate the temperature of high-voltage and other components contained therein, in particular the DC-DC converter system 30 and the optional HV-LV converter 43. By way of example and not of limitation, the thermal management system 25 may include a heat sink with conductive and/or forced convective devices, e.g., cooling plates, fans, etc., fluidic means such as coolant loops/pumps, cooling blankets, and the like. In some implementations, the thermal management system 25 could include optional phase change materials to optimize mass, transient heat rejection capability, etc.

DC-DC CONVERTER SYSTEM (30): the DC-DC converter system 30 shown schematically in FIG. 2 may be configured as a matched pair (or plurality/n-tuple) of isolated DC-DC converters capable of series or parallel operation. The DC-DC converter system 30 as constructed herein provides a flexible architecture based on modular “building blocks” of low-voltage unidirectional or bidirectional converters to output low-voltage or high-voltage depending on the voltages of the donor EV 12D and recipient EV 12R. For illustrative consistency, low-voltage as used in the following examples is a maximum or rated voltage about 400V and high-voltage is a maximum or rated voltage about 800V, without limiting the teachings to such nominal maximum voltages.

The system controller 40 of FIG. 2 may be programmed to monitor voltages and currents shared by such series/parallel connected converters by adjusting voltage/current commands (CC₃₀) to the individual converters. For instance, the system controller 40 may be configured to perform the described control actions in response to input signals indicative of input and output voltages as set forth herein, e.g., by commanding conversion of an input voltage between input terminals of the DC voltage bus into an output voltage between output terminals of the HV bus 60. This may occur via communication of switching control signals to respective first and second DC-DC converters 30A and 30B as described herein.

Referring to FIG. 3, the DC-DC converter system 30 in accordance with an embodiment includes the respect first and second converters 30A and 30B (Converter #1 and Converter #2), which in turn may be configured as buck-boost or boost-buck converters. For instance, in keeping with the non-limiting 400V-800V example maximum voltage range noted above, the first and second converters 30A and 30B may be configured in a possible implementation as identical 400V/50 kW buck-boost converters. The first and second converters 30A and 30B are connected to the HV bus 60 (also shown in FIG. 2), such that the first and second converters 30A and 30B both are connected to positive and negative input and output rails thereof, i.e., HVI⁺, HVI⁻ and HVO⁺, HVO⁻, respectively.

The DC-DC converter system 30 of FIG. 3 includes first and second switching circuits 65 and 165. The first switching circuit 65 includes switches S1, S2, and S3. Similarly, the second switching circuit 165 includes switches S4, S5, and S6. The switches S1-S6 may be variously embodied as electromechanical switches, contactors, relays, or solid-state relays (SSRs) having ON/OFF (closed/open) states that are commanded by the system controller 40 or other suitable control circuitry using the switching control signals (CC₃₀).

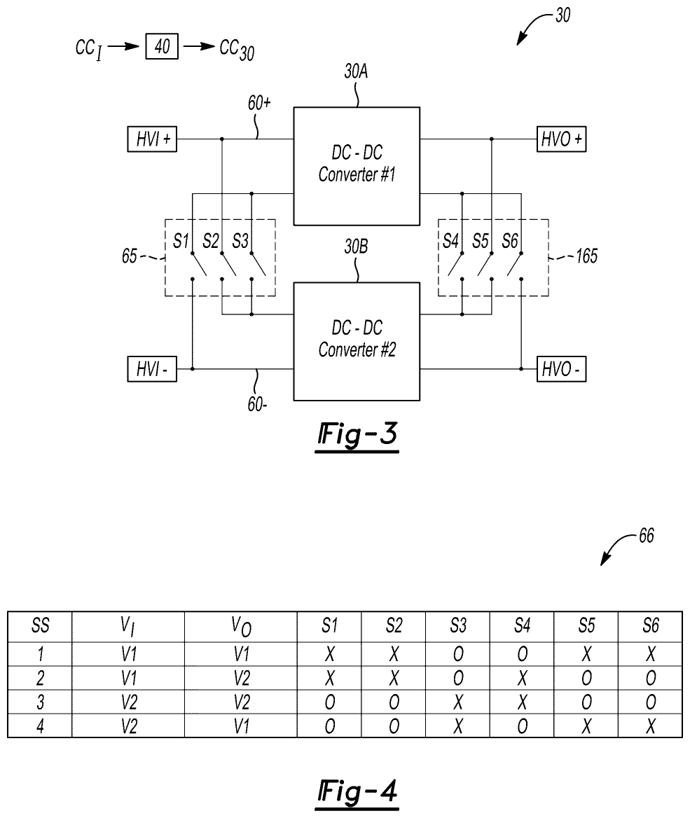

In the illustrated topology, the first converter 30A and the second converter 30B are respectively connected to the positive and negative voltage rail of the HV bus 60, i.e., directly/without an intervening switching device. Switches S1 and S6 selectively connect the first converter 30A to the negative voltage rail. In a similar vein, switches S2 and S5 selectively connect the second converter 30B to the positive voltage rail respectively upstream and downstream of the first converter 30B. Switches S3 and S4 for their part are controlled in coordination with switches S1, S2, S5, and S6 to provide the functionality of FIG. 4.

Referring now to FIG. 4, a table 66 illustrates nominal voltage input and output states (VI, VO) provided by operation of the representative circuit of FIG. 3, e.g., in the V2V charging unit 14 of FIG. 2 or other systems. In this instance, V1 represents a relatively low maximum voltage level, e.g., 400V, and V2 represents a relatively high maximum voltage level such as 800V, with other maximum voltage levels being possible in different implementations. In table 66, a conducting/ON/closed state of a corresponding one of the switches S1-S6 is indicated by “X”. Conversely, a non-conducting/OFF/open state of a corresponding one of the switches S1-S6 is indicated by “O”. Following the table 6, therefore, one may use the DC-DC converter system 30 of FIG. 3 to support input/output combinations of V1/V1, V1/V2, V2/V2, or V2/V1 simply by controlling the state of the constituent switches S1-S6 as indicated.

For example, for a representative V2V charging process 10 in which the donor EV 12D is capable of providing a maximum 800V charge to a recipient EV 12R capable of receiving a maximum charge at 400V, the system controller 40 would command switches S1, S2, and S4 to open and switches S3, S5, and S6 to close. Alternatively, if the scenario were one in which the donor EV 12D is capable of providing a maximum 400V charge to a recipient EV 12R capable of receiving a maximum 800V charge, the system controller 40 would command switches S1, S2, and S4 to close and switches S3, S5, and S6 to open. In either case, the hardware of the modular “building block” first and second converters 30A and 30B is rated for the lower of the maximum voltages, or 400V instead of 800V in this exemplary use case. Operation of such a modular implementation is more efficient and has other attendant sourcing and manufacturing benefits relative to use of a wider range multi-stage DC-DC converter as noted above.

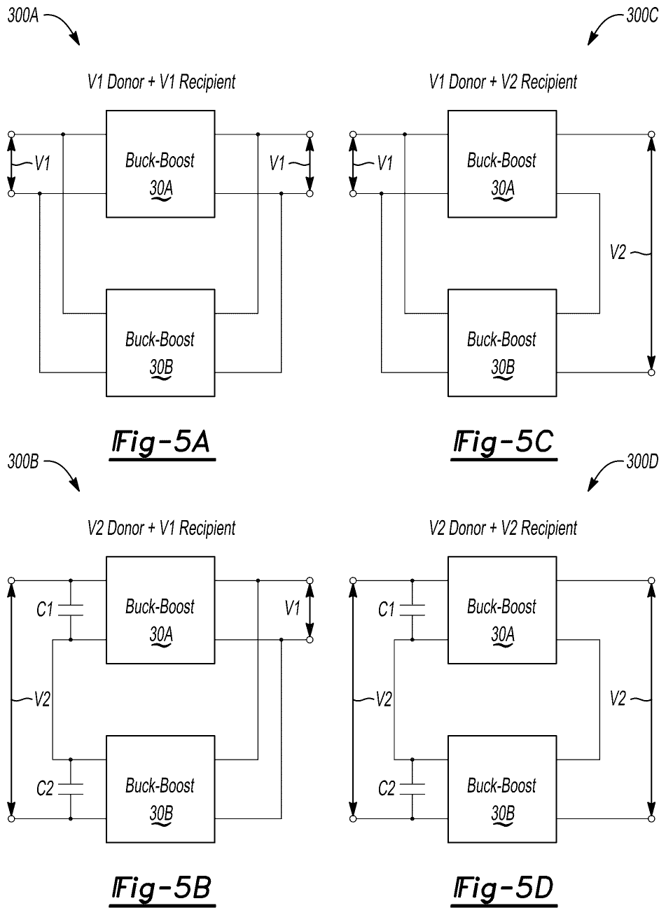

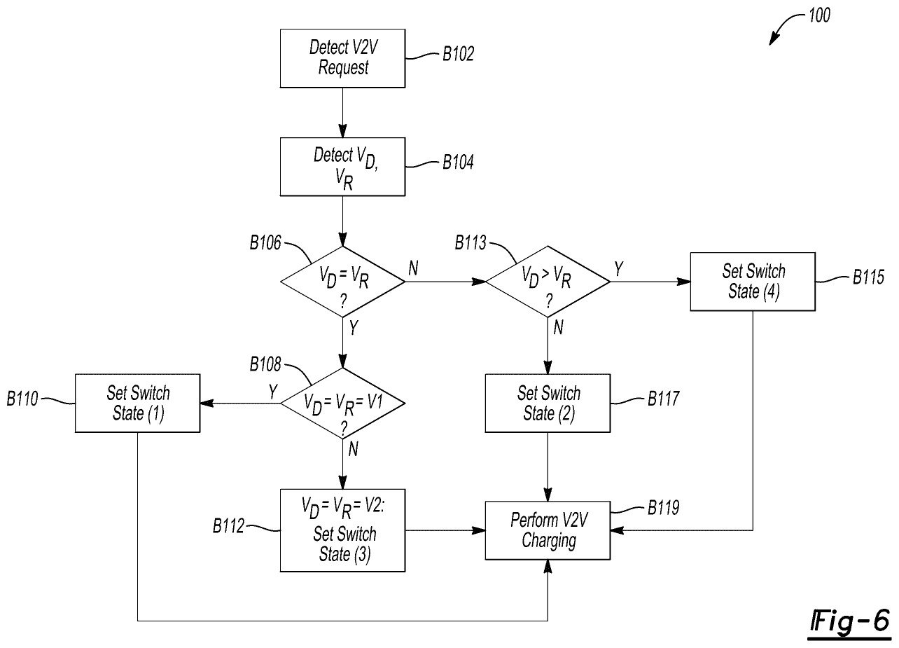

Referring to FIGS. 5A-5D, the present teachings may be implemented using preconfigured DC-DC converter systems 300A-300D as an alternative to the use of real-time switching control. Such topologies forego use of the above-described switching circuits 65 and 165 of FIG. 3 and table 66 of FIG. 4 while retaining the lower-voltage modular or “building block” construction depicted in FIG. 3. The DC-DC converter systems 300A-300D of FIGS. 5A-5D address the same four maximum voltage level possibilities described in table 66, i.e., the donor EV 12D and recipient EV 12R are respectively at (i) V1, which is illustrated in FIG. 5A, (ii) V1 and V2 (FIG. 5B), (iii) V2 and V1 (FIG. 5C), or (iv) V2 (FIG. 5D). Due to the higher voltage level (V2) on the input side of the representative topologies of options (ii) and (iv), respective first and second capacitors (C1 and C2) may be used to divide the voltage (V2) into respective V1 voltages at the inputs to the first and second converters 30A and 30B.

Referring to FIG. 6, a method 100 is illustrated for performing the V2V charging process 10 of FIG. 1 using the representative DC-DC converter system 30 of FIG. 3. The method 100, which may be performed via the system controller 40 of FIGS. 2 and 3 and/or using other control processors in different implementations, is illustrated in discrete code segments or logic blocks, each of which may be embodied as computer-readable instructions recorded in a non-transitory computer-readable storage medium accessible by the system controller 40.

Beginning with block B102 (“Detect V2V Request”), the method 100 includes detecting a V2V charging request. This may entail connecting the donor EV 12D to the recipient EV 12R via the V2V charging unit 14 of FIG. 2 or another charger equipped with the DC-DC converter system 30 of FIG. 3. Once the donor EV 12D and recipient EV 12R have been connected together and communicate via charging protocols set forth above and appreciated in the art, the method 100 proceeds to block B104.

Block B104 (“Detect V_{D}, V_{R}”) includes detecting the voltage levels/maximum voltage capabilities of the donor EV 12D and recipient EV 12R, i.e., V_{D} and V_{R} in FIG. 6. Such information is exchanged between the controllers 32 and 132 (FIG. 2) in the course of a typical EV charging event, as appreciated in the art. The method 100 proceeds to block B106 once the system controller 40 has ascertained the respective maximum voltages of the donor EV 12D and recipient EV 12R.

Block B106 (“V_{D}=V_{R}?”) includes comparing the respective maximum voltage levels of the donor EV 12D and recipient EV 12R from block B104, e.g., via a comparator circuit or logic of the system controller 40, to determine if the voltages are equal. The method 100 proceeds to block B108 when VD=VR, and to block B113 in the alternative when the respective maximum voltage levels of the donor EV 12D and recipient EV 12R are different, e.g., to within an application-specific calibrated tolerance.

At block B108 of FIG. 6, the system controller 40 next determines whether respective maximum voltage levels of the donor EV 12D and recipient EV 12R are equal to a predetermined first voltage level (V1). As described above with reference to FIG. 3, V1 may be a relatively low maximum/rated voltage level such as 400V in the non-limiting example used above. The method 100 proceeds to block B110 once the system controller 40 has ascertained that V_{D}=V_{R}=V1. The method 100 otherwise proceeds to block B112.

At block B110 (“Set Switch State (1)”), the system controller 40 sets the switches S1-S6 of FIG. 3 equal to the first switch state (1). That is, the system controller 40 commands the switches S1, S2, S5, and S6 to close (X) and switches S3 and S4 to open (O). The method 100 thereafter proceeds to block B119.

At block B112 (“Set Switch State (3)”), the system controller 40 sets the switches S1-S6 of FIG. 3 equal to the first switch state (3). That is, the system controller 40 commands the switches S3 and S4 to close (X) and switches S1, S2, S5, and S6 to open (O). The method 100 thereafter proceeds to block B119.

At block B115 (“Set Switch State (4)”), the system controller 40 sets the switches S1-S6 of FIG. 3 equal to the first switch state (4). That is, the system controller 40 commands the switches S3, S5, and S6 to close (X) and switches S1, S2, and S4 to open (O). The method 100 thereafter proceeds to block B119.

At block B117 (“Set Switch State (2)”), the system controller 40 sets the switches S1-S6 of FIG. 3 equal to the second switch state (2). That is, the system controller 40 commands the switches S1, S2, and S4 to close (X) and switches S3, S5, and S6 to open (O). The method 100 thereafter proceeds to block B119. V2V charging thereafter continues until charging is complete, either by reaching a target SOC of the battery pack 118 of the recipient EV 12R or in response to termination of the V2V charging process 10 due to a detected fault, user command, other scheduled or non-scheduled interruption.

Block B119 (“Perform V2V Charging”) of FIG. 6 includes commencing offloading of the DC charging current (DC-1) of FIG. 1 from the donor EV 12D to the V2V charging unit 14, and the DC charging current (DC-2) from the V2V charging unit 14 to the recipient EV 12R.

The real-time switching control embodiment of FIG. 3 and the preconfigured embodiments of FIGS. 5A-5D are thus made available by the present disclosure as modular alternatives to use of a DC-DC converter having a wide input range, e.g., 400V to 800V in keeping with the above described V1 and V2 embodiments. Use of the present solutions may help improve overall charging efficiency while potentially reducing charging time and thermal stress. The foregoing solutions when used aboard the representative V2V charging unit 14 of FIG. 2 may also expedite charging and increase charging options/flexibility relative to using EVSE station-driven charging operations. These and other attendant benefits will be readily understood by those skilled in the art in view of the foregoing disclosure.

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A direct current-to-direct current (DC-DC) converter system, comprising:
a galvanically-isolated, modular first DC-DC converter having a predetermined voltage rating;
a galvanically-isolated, modular second DC-DC converter having the predetermined voltage rating;
a direct current (DC) voltage bus that interconnects the first DC-DC converter and the second converter; and
an electronic controller configured to convert an input voltage to the DC voltage bus into an output voltage from the DC voltage bus via switching control signals to the first DC-DC converter and the second DC-DC converter.

2. The DC-DC converter system of claim 1, wherein predetermined voltage rating is equal to a maximum of the input voltage or a maximum of the output voltage.

3. The DC-DC converter system of claim 2, wherein the predetermined voltage rating is equal to the maximum of the input voltage, and is about 50-percent of the maximum of the output voltage.

4. The DC-DC converter system of claim 1, wherein a maximum of the input voltage is equal to a maximum of the output voltage.

5. The DC-DC converter system of claim 4, wherein the predetermined voltage rating is about 50-percent of the maximum of the input voltage, further comprising:
a first capacitor connected in parallel with the first DC-DC converter on an input side thereof; and
a second capacitor connected in parallel with the second DC-DC converter on an input side thereof.

6. The DC-DC converter system of claim 5, wherein the predetermined voltage rating is about 50-percent of the maximum of the output voltage.

7. The DC-DC converter system of claim 1, further comprising:
a first switch circuit connected to the DC voltage bus and having a first plurality of switches; and
a second switch circuit connected to the DC voltage bus and having a second plurality of switches,
wherein the electronic controller is configured, in response to input signals indicative of the input voltage and the output voltage, to control an ON/OFF switching state of the first plurality of switches and the second plurality of switches to convert the input voltage into the output voltage via the switching control signals.

8. The DC-DC converter system of claim 7, wherein the first plurality of switches includes a first switch, a second switch, and a third switch, and the second plurality of switches includes a fourth switch, a fifth switch, and a sixth switch.

9. The DC-DC converter system of claim 8, wherein the electronic controller is configured to command the first switch, the second switch, the fifth switch, and the sixth switch to close and the third switch and the fourth switch to open in response to the input voltage and the output voltage being equal to the predetermined voltage rating.

10. The DC-DC converter system of claim 9, wherein the electronic controller is configured to command the first switch, the second switch, the fourth switch to close and the third switch, fifth switch, and the sixth switch to open in response to the input voltage being equal to the predetermined voltage rating and the output voltage being twice the input voltage.

11. The DC-DC converter system of claim 10, wherein the electronic controller is configured to command the third switch and the fourth switch to close and the first switch, the second switch, the fifth switch, and the sixth switch to open in response to the input voltage and the output voltage being equal to twice the predetermined voltage rating.

12. The DC-DC converter system of claim 11, wherein the electronic controller is configured to command the third switch, the fifth switch, and the sixth switch to close and the first switch, the second switch, and the fourth switch to open in response to the input voltage being equal to twice the predetermined voltage rating and the output voltage being equal to the predetermined voltage rating.

13. The DC-DC converter system of claim 1, wherein the predetermined voltage rating is about 400 volts.

14. The DC-DC converter system of claim 1, wherein the DC-DC converter system is connected to and/or within a housing of a vehicle-to-vehicle charging unit, the input voltage is a battery voltage level of a traction battery pack of a donor electric vehicle (EV), and the output voltage is a battery voltage level of a traction battery pack of a recipient EV.

15. A vehicle system comprising:
a charge-providing donor electric vehicle (EV);
a charge-receiving recipient EV; and
a vehicle-to-vehicle (V2V) charging unit, the V2V charging unit having an electronic controller and a DC-DC converter system for use in performing a V2V charging process between the donor EV and the recipient EV, the DC-DC converter system comprising:
a galvanically-isolated, modular first DC-DC converter having a predetermined voltage rating;
a galvanically-isolated, modular second DC-DC converter having the predetermined voltage rating; and
a DC voltage bus interconnecting the first DC-DC converter and the second converter, wherein electronic controller configured to convert an input voltage to the DC voltage bus into an output voltage from the DC voltage bus via switching control signals to the first DC-DC converter and the second DC-DC converter.

16. The vehicle system of claim 15, the DC-DC converter system comprising:
a first switch circuit connected to the DC voltage bus and having a first plurality of switches; and
a second switch circuit connected to the DC voltage bus and having a second plurality of switches, wherein the electronic controller is configured, in response to input signals indicative of the input voltage and the output voltage, to control an ON/OFF switching state of the first plurality of switches and the second plurality of switches to convert the input voltage into the output voltage via the switching control signals.

17. The vehicle system of claim 15, wherein the predetermined voltage rating is about 400 volts and the input voltage and the output voltage are 400 volts or 800 volts.

18. A direct current-to-direct current (DC-DC) charging process, comprising:
detecting, via an electronic controller of a charging unit when the charging unit is connected to a charge-providing battery electric system (“donor”) and a charge-receiving battery electric system (“recipient”), respective voltage capabilities of a donor-side battery and a recipient-side battery of the respective donor and recipient; and
in response to the respective voltage capabilities:
converting an input voltage to a DC voltage bus within the charging unit into an output voltage of the DC voltage bus via provision of switching control signals to a galvanically-isolated, modular first DC-DC converter and a galvanically-isolated, modular second DC-DC converter of the charging unit, wherein a predetermined voltage rating of the first DC-DC converter is equal to a predetermined voltage rating of the second DC-DC converter.

19. The DC-DC charging process of claim 18, wherein converting the input voltage includes controlling ON/OFF switch states of (i) a first switch circuit connected to the DC voltage bus and having a first plurality of switches, and (ii) a second switch circuit connected to the DC voltage bus and having a second plurality of switches.

20. The DC-DC charging process of claim 19, wherein detecting the respective voltage capabilities of the donor-side battery and the recipient-side battery of the respective donor and recipient includes receiving an input signal, via a system controller of the charging unit, from a controller of the donor and a controller of the recipient.
